(19) United States
(12) Patent Application Publication
(10) Pub. No.: US 2005/0198224 A1
(43) Pub. Date: Sep. 8, 2005

(54) Storage network system and control method thereof

(76) Inventors: Emiko Kobayashi, Yokohama (JP); Takeshi Ishizaki, Yokohama (JP); Kiminori Sugauchi, Yokohama (JP); Atsushi Ueoka, Yokohama (JP); Toui Miyawaki, Yokohama (JP); Jun Mizuno, Yokohama (JP)

Correspondence Address: Mattingly, Stanger & Malur, P.C, Suite 370, 1800 Diagonal Road, Alexandria, VA, 22314, US

(21) Appl. No.: 10/874,330

(22) Filed: Jun. 24, 2004

(30) Foreign Application Priority Data
Mar. 2, 2004 (JP) 2004-057613

(51) Int. Cl. G06F 15/173

(52) U.S. Cl. 709/220

(57) ABSTRACT

A control condition is automatically generated by using a discovery domain managed by an iSNS server as a network communication quality control unit and set in a network device. Thus, it is possible to realize communication whose quality is effectively controlled in storage data transmission. A network configuration server automatically acquires discovery domain information which groups a host and a storage apparatus managed by a name management server. The network configuration server sets a flow identification condition so as to identify the flow per discovery domain according to the information acquired, assigns a service class performing a control of quality of communication service to the flow, and sets transmission rule for the service class to routers.

### INCORPORATION BY REFERENCE

The present application claims priority from Japanese application JP2004-057613 filed on Mar. 2, 2004, the content of which is hereby incorporated by reference into this application.

### BACKGROUND OF THE INVENTION

The present invention relates to a storage network system and a control method thereof and in particular to a storage network system and control method thereof for controlling a network for guaranteeing quality of service (QoS) of communication in the data transmission between a storage apparatus and a host connected to the network.

In general, a high speed and a high throughput are required for data transmission between a server and a storage apparatus using a storage area network (SAN) connecting various job servers and storage apparatuses. Conventionally, the fiber channel used in the storage network has a high transmission rate and can realize a high-rate large-capacity transmission by block transmission, causing no problem in the transmission quality. Recently, the SAN built by the Internet protocol is widely spread. In the case of the IP network, increase of the transmission rate is limited. Accordingly, a control of quality of communication service is required to assure a transmission bandwidth and guarantee a communication rate.

As a conventional technique for controlling the quality of communication service of network, the standardization organization IETF (Internet Engineering Task Force) defines the technique of RSVP (Resource Reservation Protocol) for successively requesting a router on a communication path so as to assure a communication path which has assured a communication bandwidth in order to surely perform communication by an end user and the technique of Differentiated Services (hereinafter, referred to as Diff Serv) for classifying communication according to the source, destination address, application, and the like in the router and differentiating the quality of communication service (RFC2475). For example, U.S. Patent Publication 2002/0112030 A1 discloses a technique concerning a storage system in which access speed is guaranteed by considering the communication rate between the host and the storage apparatus and the communication rate in the storage apparatus according to the RSVP.

Moreover, as another conventional technique, there is known a method for performing the QoS control between terminals (end to end) according to the traffic type without contradiction in the entire network by using the policy server integrally managing the setting of the quality control of the network devices at one position.

On the other hand, from the viewpoint of security of the storage system, the storage apparatus and the logical unit in the storage apparatus, which can be accessed by a server, may be limited. In this case, in order to establish a session, the server may detect a storage apparatus which can be accessed. In the storage network by the IP, there is provided one used in such a case which is called Internet Storage Name Service (iSNS). This defines the server and the storage apparatus in the accessible range by a group which is called a discovery domain and this definition is managed by the name server (see http://www.ietf.org/internet-drafts/draft-ietf-ips-isns-22.txt). In order to limit the visibility of the storage device, upon discovery request from the host, the name server returns only the information on the storage device belonging to the same discovery domain as the host. The device such as a job server and a storage apparatus is identified by the address, port number, node name, and the like and may belong to one of the discovery domains. As a method for defining the discovery domain, there can be considered a method for performing definition for each job AP (Application Program) by handling as one domain the server providing the job AP and the storage apparatus storing the data used in the AP.

As has been described above, in a large-scale storage network in which various job AP data are mixed when they are transmitted, different communication qualities are required for the respective job AP and it is preferable to control the quality of communication service for each AP.

In the storage network according to the conventional technique, no consideration has been taken on control of the transmission quality. Accordingly, even when a network is built by the IP, there is a problem that no method has been established to decide on which basis control of the quality of communication service if performed in the storage network. The storage system has a discovery domain which can be considered as a group for providing a job AP. However, in the conventional technique, no technique has been established how to map this on the network control information and how to control the quality of communication service.

Furthermore, the storage apparatus consists of a plurality of logical units and an access source is limited for each logical unit. For this, the access source server job and the data importance may be decided for each logical unit. However, in the conventional technique, there is a problem that no consideration is taken on control of the network considering the logical unit.

### SUMMARY OF THE INVENTION

It is therefore an object of the present invention to provide a storage network system and a control method thereof capable of solving the aforementioned problems of the conventional technique and realizing effectively a control of quality of communication service in the storage data transmission.

In order to achieve the aforementioned object, a control method of a storage network system including a plurality of information processing apparatuses and a plurality of storage apparatuses further includes a name management server which manages domain information used for searching a storage apparatus accessible by the information processing apparatuses and a network configuration server which acquires domain information managed by the name management server and sets network control information per domain to devices constituting the network.

According to the present invention, it is possible to automatically generate a control condition by using the discovery domain as a unit for performing a control of quality of communication service of network and set it to the network devices. Moreover, it is possible to omit setting of communication control in the storage network system and to control quality of data transmission between the job servers and storage apparatuses on the basis of the discovery domain information.

### BRIEF DESCRIPTION OF THE DRAWINGS

FIG. 1 is a block diagram showing configuration of a storage network system according to an embodiment of the present invention.

FIG. 2 is a block diagram showing configuration of a storage apparatus.

FIG. 3 is a block diagram showing router configuration.

FIG. 4 explains priority control which is one of the QoS controls performed by the router.

FIG. 5 explains the QoS control in the entire network based on the frame work of Diff Serv.

FIG. 6 is a block diagram showing hardware configuration of a name management server.

FIG. 7 shows configuration of a table of name management information held by the name management server.

FIG. 8 is a block diagram showing hardware configuration of the network configuration server.

FIG. 9A and FIG. 9B show configuration of tables of the QoS setting information held by the network configuration server.

FIG. 10A and FIG. 10B show a sequence of addition of a node (a host and/or a storage apparatus) and a sequence of deletion from the discovery domain.

FIG. 11 is a flowchart explaining the processing operation of the QoS setting program for acquiring information in the network configuration server.

FIG. 12 shows a service cluster mapping table of the network configuration server.

### DETAILED DESCRIPTION OF THE EMBODIMENTS

Description will now be directed to a storage network system and a control method thereof according to embodiments of the present invention with reference to the attached drawings.

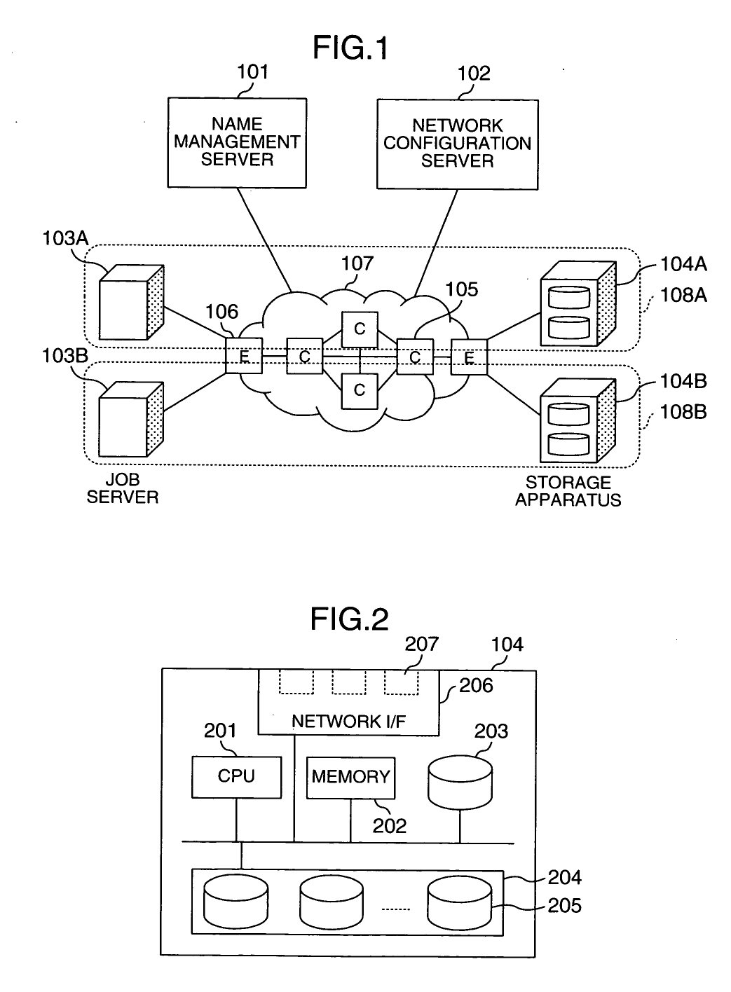

FIG. 1 is a block diagram showing configuration of the storage network system according to an embodiment of the present invention. In FIG. 1, 101 denotes a name management server, 102 denotes a network configuration server, 103A and 103B denote job servers, 104A and 104B denote storage apparatuses, 105 denotes a core router, 106 denotes an edge router, 107 denotes a network, and 108A and 108B denote discovery domain groups.

The storage network system according to an embodiment of the present invention shown in FIG. 1 includes a network 107 consisting of network devices such as a router and a switch which are connected to a plurality of job servers 103A, 103B and a plurality of storage apparatuses 104A, 104B as well as a name management server 101 and a network configuration server 102. The network 107 consists of a 0 or a plurality of routers (called core router) 105 constituting a network and a router (called edge router) at output/input of the network 107 connected to the job server and the storage apparatus. The name management server 101 connected to the network 107 manages the name and address of the storage apparatus and the host and group information. The network configuration server 102 integrally manages quality control of the network devices and performs setting at one position.

In the embodiment of the present invention explained below, for clarification of explanation, it is assumed that a job server 103A and a storage apparatus 104A constitute one discovery domain group 108A while a job server 103B and a storage apparatus 104B constitute another discovery domain group 108B.

In the example shown in FIG. 1, the job server and the storage apparatus are connected directly to the network 107. However, the job server and the storage apparatus may also be connected via a local area network. Moreover, in the example shown in FIG. 1, the job server and the storage apparatus are connected to the same router, respectively. However, the present invention is not to be limited to this configuration.

Between the host and the storage apparatus, data accompanying data access such as write onto the disc and read out is transmitted. In the embodiment of the present invention, IP is used as a network protocol. However, the present invention is not to be limited to this. For storage access on the IP, for example, protocols such as iSCSI and iFCP are used.

FIG. 2 is a block diagram showing configuration of the storage apparatus. As shown in FIG. 2, each of the storage apparatuses 104A and 104B includes a CPU, a memory 202, a storage apparatus group 204 consisting of a plurality of logical units 205, a storage apparatus 203 for storing control information on the logical unit 205, and a network interface 206. A storage control program performing control of the logical unit 205 and a communication control program are loaded on the memory 202 and these programs are executed by the CPU 201. A network I/F 206 can define a plurality of logical ports 207 as access input and output. Thus, it is possible to distinguish the accessible logical unit for each logical port.

Moreover, the job server, although not depicted, is a well-known host computer (hereinafter, referred to as a host) including a CPU, a memory, a storage apparatus, and a network I/F. An application program (AP) is loaded on the memory and executed by the CPU. The AP accesses the storage apparatus via the network I/F and realizes data input/output to/from the storage apparatus group.

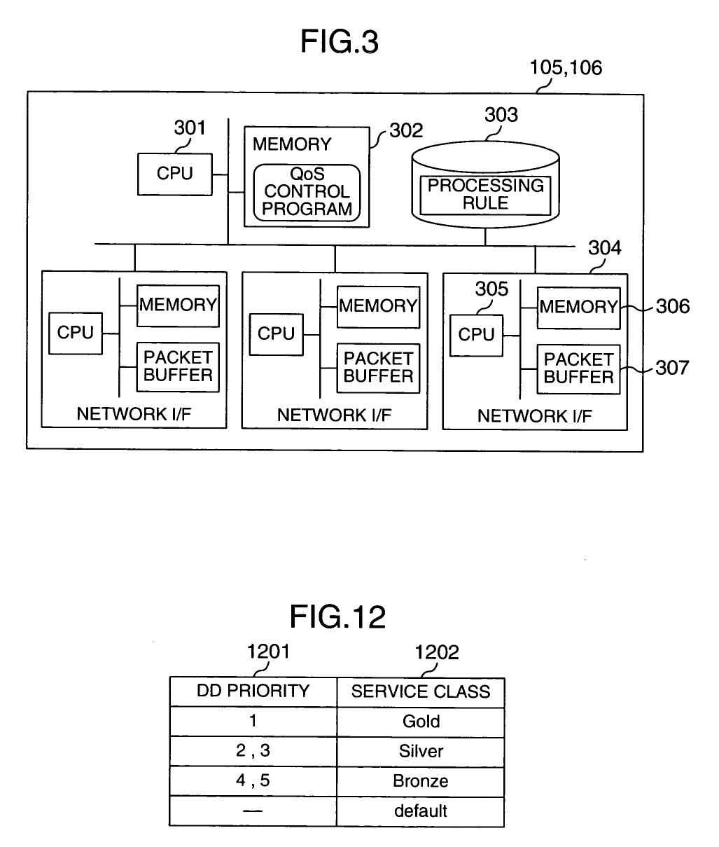

FIG. 3 is a block diagram showing configuration of a router. As shown in FIG. 3, each of the routers 105 and 106 includes a CPU 301, a main memory 302, a secondary storage apparatus 303, and a plurality of network I/F 304. Each of the network I/F 304 includes a CPU 305, a memory 306, and a packet buffer 307. A program executing the route control and the QoS control is loaded on the main memory and executed by the CPU 301. The route program judges the packet destination I/F and the packet relay is controlled. Here, a packet group classified by the header such as address and a packet feature is called a flow. The QoS control technique performed by the router includes, for example, priority control, queue drop control, and bandwitdth control.

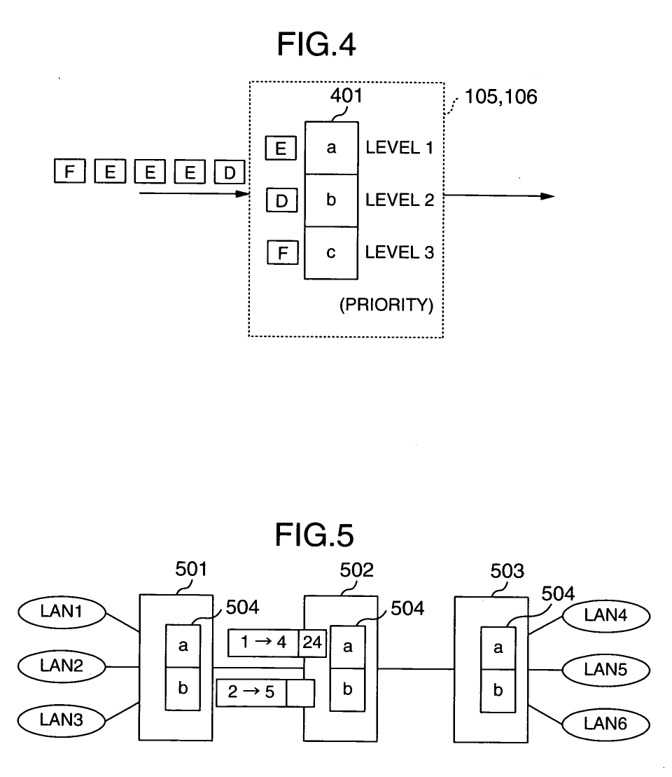

FIG. 4 is a diagram explaining priority control which is one of the QoS controls performed by the router. Explanation will be given on this control. In FIG. 4, 401 denotes an output queue.

When performing priority control during packet relay, the router assigns priority level (level 1 is the maximum level) to the output queue 401 to the network and controls the packet output sequence. For example, three types of queue are available for output to a network and it is assumed that they relay different flows D, E, and F. Moreover, three priority levels: level 2, level 1, and level 3 are given to each of the flows D, E, and F. In this case, the flow E is relayed by using a queue 401a to which level 1 is assigned; the flow D is relayed by using a queue 401b to which level 2 is assigned; and the flow F is relayed by using a queue 401c to which level 2 is assigned. After output of all the packets of the queue 401a of level 1 is complete, the router outputs queue packet in the order of the queue 401b of level 2 and the queue 401c of level 3.

FIG. 5 is a diagram explaining the QoS control in the entire network according to the Diff Serv frame work. In the example of FIG. 5, LAN 1-3 and LAN 4-6 are connected by a network consisting of edge routers 501, 503 and core router 502. An output queue in each router is divided into a priority queue “a” and a non-priority queue “b”.

When performing communication from LAN 1 to LAN 4, the edge router 501 at the input of the network identifies the flow of the packet which has been input, decides the corresponding service class, and writes a value corresponding to the service class into the packet header portion. This value is called DSCP (Diff Serv Code Point). In the example shown in FIG. 5, the packet from LAN 1 to LAN 4 is shows as “1→4 24” wherein “1→4” represents a packet from LAN 1 to LAN 4 and “24” represents the DSCP. The core router 502 and the edge router 503 at the output read the DSCP of the header for each packet received and decides the output queue according to the transmission rule. Thus, it is possible to guarantee quality of communication service between the LAN 1 and LAN 4 without being affected by the communication between other LANs. In addition to the priority control according to the service class, the router can perform bandwidth control and packet drop control. The processing rule is set from the network configuration server.

The router processing is not to be limited to the aforementioned one. The processing may be transmission based on the MPLS (Multi Protocol Label Switching) using the DSCP.

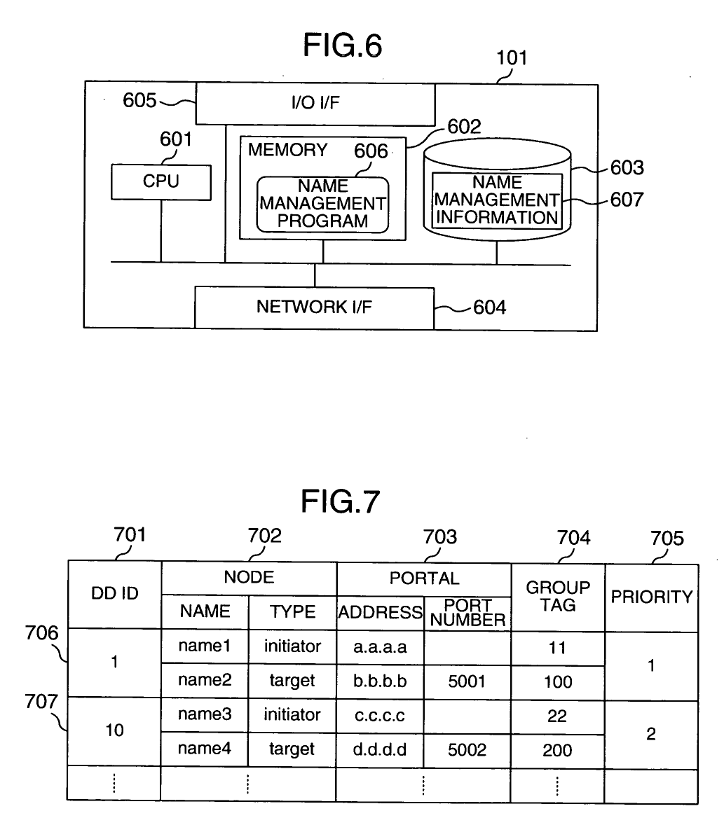

FIG. 6 is a block diagram showing hardware configuration of the name management server. In FIG. 6, 601 denotes a CPU, 602 denotes a memory, 603 denotes a storage apparatus, 604 denotes a network I/F, 605 denotes an I/O I/F, 606 denotes a name management program, and 607 denotes name management information.

As shown in FIG. 6, the name management server 101 includes the CPU 601, the memory 602, the storage apparatus 603, the network I/F 604, and the I/O IL/F 605. The name management program 606 is stored in a storage apparatus such as a hard disc, loaded on the memory 602, and executed by the CPU 601. Moreover, in the storage apparatus 603, the name management information 607 is stored. The I/O I/F 605 is connected to I/O devices (not depicted) such as a keyboard, a mouse, and a display for an operator.

In the storage network system shown in FIG. 1, the name management server 101 is shown as independent hardware. However, the name management program 606 may be executed with another program by an information processing apparatus having the same hardware components as in the one shown in FIG. 6 and network devices such as a switch.

Here, the name management program 606 realizes the iSNS and uses the iSNS protocol for communication. However, the present invention is not limited to this. The host and the storage apparatus can be made into a group for limiting the access authorization and registered as one belonging to the discovery domain in the name management server 101. The name management server 101 performs manages the apparatus by the node and a portal as an access input to the node network. A plurality of nodes and portals may be present in one apparatus. The nodes and portals are registered independently from each other. For correlation between the nodes and the portals, portal group tags uniquely defined are attached to the nodes.

FIG. 7 is shows table configuration of the name management information held by the name management server. Next, explanation will be given on this.

The table of the name management information 107 includes a field 701 of the discovery domain identifier (DD ID), a field 702 of the node for setting a type (initiator or target) and a name as node information belonging to the discovery domain, a field 703 of the portal for setting an address and a port number as network portal information belonging to the discovery domain, and a filed 704 of the portal group tag. In FIG. 7, a filed 705 of the priority is shown. This will be detailed later and not used in the example explained here.

For example, as explained with reference to FIG. 1, when the node (name 1) and the portal 1 (address a.a.a.a) of the host 1 (job server 103A) and the node (name 2) and the portal 2 (address b.b.b.b port 5001) of the storage apparatus 1 (storage apparatus 104A) are set in the discovery domain 1 (108A), the entry of the discovery domain 1 is shown by the entry 706. Moreover, when the node (name 3) and the portal 3 (address c.c.c.c) of the host 2 (job server 103B) and the node (name 4) and the portal 4 (address d.d.d.d) of the storage apparatus 2 (storage apparatus 104B) are set in the discovery domain 2 (108B), the entry of the discovery domain 2 is shown by the entry 707.

In response to inquiry from a client, the name management server 101 responds information on the node and the portal belonging to the same discovery domain. Moreover, input of the management information to the name management server 101 can be performed via the I/O I/F 605 by the operator. Furthermore, when the change occurs in the name management information of the discovery domain to which the apparatus belongs, the name management server 101 receives registration of an apparatus to which notification is to be sent. Each apparatus which wants to receive the notification performs a registration request to the name management server.

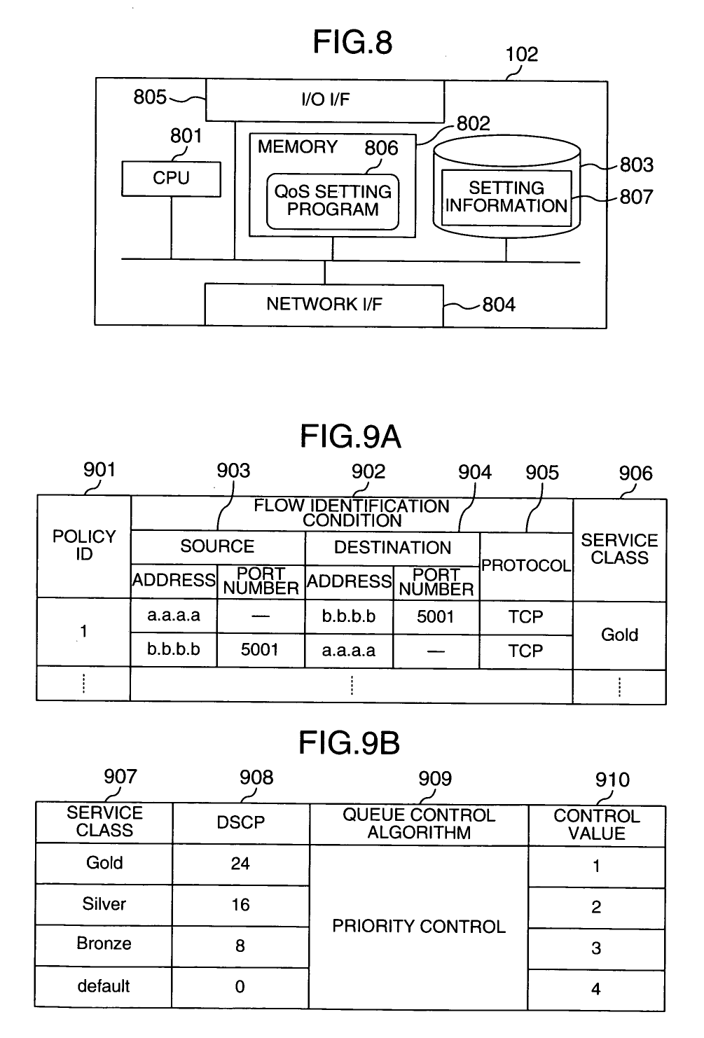

FIG. 8 is a block diagram showing hardware configuration of the network configuration server 102. The network configuration server 102 includes a CPU 801, a memory 802, a storage apparatus 803, a network I/F 804, and an I/O I/F 805. The QoS setting program 806 is stored in a storage apparatus such as a hard disc, loaded on the memory 802, and executed by the CPU. Moreover, the network configuration information and QoS setting information 807 are stored in the storage apparatus 803. The network configuration server 102 recognizes the each router position (edge or core), I/F configuration, and address as network configuration information.

FIG. 9A and FIG. 9B show table configurations of the QoS setting information 807 held by the network configuration server 102. Explanation will now be given on this. There are two types of QoS setting information tables: a table for managing the flow identification condition and the service class shown in FIG. 9A and a table for managing the control method and the control value corresponding to it shown in FIG. 9B.

The table for managing the flow identification condition and the service class shown in FIG. 9A includes a field of policy ID 901 for identifying a setting policy, a field of flow identification condition 902 specifying a source address with a port number 903, a destination address with a port number 904, and a protocol type 905, and a field of the service class 906.

The network configuration server 102 sets the flow identification condition and the service class for the edge router and sets the transmission rule for the service class on all the routers. The network configuration server 102 creates an entry of the table according to the discovery domain information received from the name management server 101. The policy ID 901 can identify the discovery domain (may have the same value as the discovery domain ID) and uniquely assigned when the entry is added. For example, for the discovery domain information of entry 1 shown in FIG. 7, “1” which is the discovery domain ID is set as the policy ID and in order to identify the flow between the host and the storage apparatus belonging, an address and a port number which are portal information are set as the flow identification condition. Since the router judges by reading the address of the source and the address of the destination, the entry is performed for each direction. Furthermore, in this table, the service class 906 for the flow is set.

The transmission rule based on the service class has a control method and a control value corresponding to it which are managed by the service management table shown in FIG. 9B which shows an example of management information. The management information shown in FIG. 9B includes a service class field 907, a corresponding DSCP field 908, a queue control algorithm field 909 indicating the queue control method, and a control value field 910 indicating the priority as the control value. The table of FIG. 9B shows an example of a case when the control method of the service class is made priority control and Gold, Silver, Bronze, and default are set as the service classes for which priority 1 to 4 are given as control values.

In the aforementioned example, the control method is priority control. In the case when the control method is a bandwidth control, the bandwidth rate can be set as a rule for the service class. In the case when the control method is a (queue) drop control, the queue length can be set as a rule for the drop control algorithm and the service class. Moreover, a plurality of control methods can be used together. In this case, each control method and control value are managed. The aforementioned transmission rule is set by the network configuration server 102 for each router. As the setting means, the network configuration server 102 connects to the router management address, logs-in, and inputs a router command.

The designation of the service class for the discovery domain is defined by a manager of the network configuration server 102 according to the importance of the job server belonging to the discovery domain, the data I/O frequency, the data amount, and the like. Moreover, the control method and control value for the service class are set by the manager or set by a dynamic resource allocation tool according to a request.

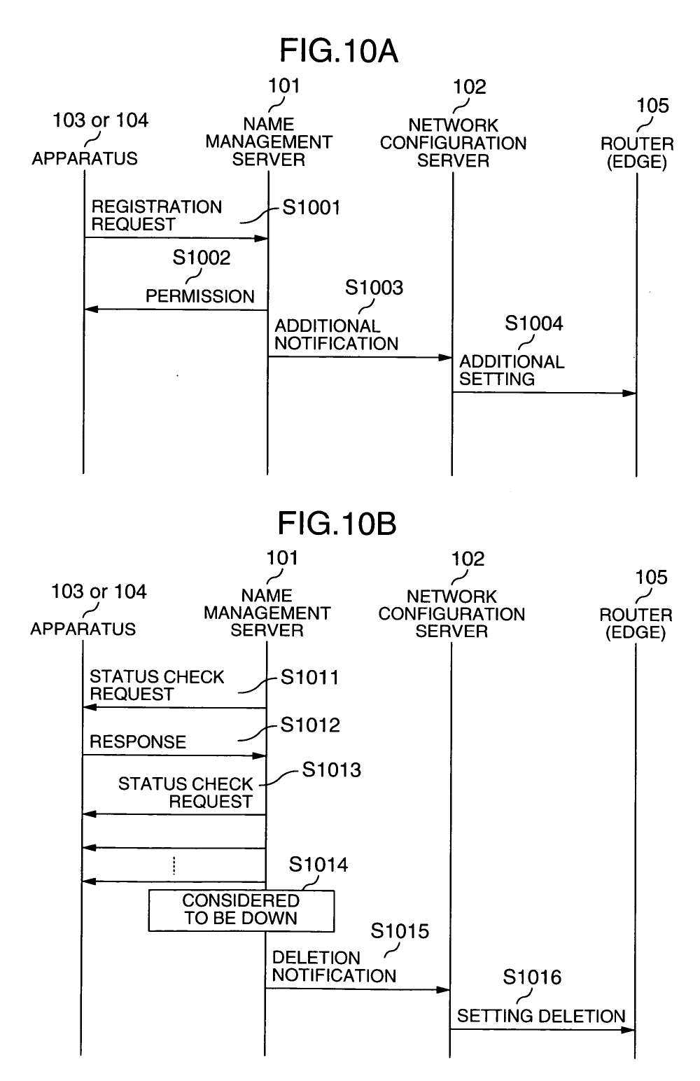

FIG. 10A and FIG. 10B show sequences for addition of a node (host and/or storage apparatus) and deletion from the discovery domain. Firstly, referring to FIG. 10A, explanation will be given on a case when a host and a storage apparatus are added.

(1) When a host or a storage apparatus is connected to a network so as to be enabled to be accessed, firstly, its information is notified to the name configuration server 101. Here, the information registered in the name management server 101 is the node and portal information explained with reference to FIG. 7 (sequence S1001).

(2) The name management server 101 judges to which discovery domain the notified node and portal information belong. This judgment is performed by using the definition file of the name management server 101 if the information is registered. Otherwise, the judgement is performed by inquiring the manager. The name management server 101 performs registration in the name management information table and notifies registration authorization to the apparatus (sequence 1002).

(3) After addition to the discovery domain, the name management server 101 notifies the information to the network configuration server 102 (sequence 1003).

(4) The network configuration server 102 references the table explained in FIG. 9 by using the discovery domain ID of the notified information as the policy ID. When the policy ID is registered, the network configuration server 102 adds the flow condition using the addition node as the source and destination for each direction to the flow identification condition, assigns the same service class, and sets a new flow condition to the edge router. Moreover, when the policy ID corresponding to the notified discovery domain ID is not contained in the table, the network configuration server 102 considers that a new discovery domain is added and creates a new policy ID entry, sets a flow identification condition, assigns a service class, and defines a transmission rule for the service class for assigning a new service class. The network configuration server 102 sets the changed flow identification condition to the edge router and sets a new transmission rule to all the routers including the core router (sequence S1004).

Next, referring to FIG. 10B, explanation will be given on deletion of the host or the storage apparatus from the discovery domain.

(1) The name management server 101 periodically performs polling to make a status check request and checks availability of the host and the storage apparatus by receiving a response (sequence S1011, S1012).

(2) When no response is received for the status check request from the apparatus, the name management server 101 transmits repeatedly the status check request several times. If no response is received after the repetition, it is judged that the availability cannot be confirmed and the apparatus in the down status. The registration information on the apparatus is deleted from the table (sequence S1013, S1014).

(3) After this, the name management server notifies the information on the discovery domain ID, the node, and the portal to which the apparatus deleted has belonged, to the network configuration server 102 (sequence S1015).

(4) The network configuration server 102 searches the entry corresponding to the QoS setting table, deletes the condition containing the address of the corresponding node in the flow identification condition from the table, and changes (deletes in this case) the setting of the flow identification condition of the edge router 105 (sequence S1016).

When deleting the discovery domain and the node information belonging to the domain by the request from the manager, the manager inputs the discovery domain information to be deleted into the name management server by using the I/O device for management. The name management server notifies the input information to the network configuration server. Moreover, the table information held by the name management server is updated. The network configuration server 102 deletes the entry of the policy ID corresponding to the discovery domain to be deleted and deletes the flow identification condition from the edge router. For the transmission rule set for all the routers, the rule of the corresponding service class is deleted. From the class number or the like, if there is another policy using the same service class as the policy to be deleted, nothing is performed.

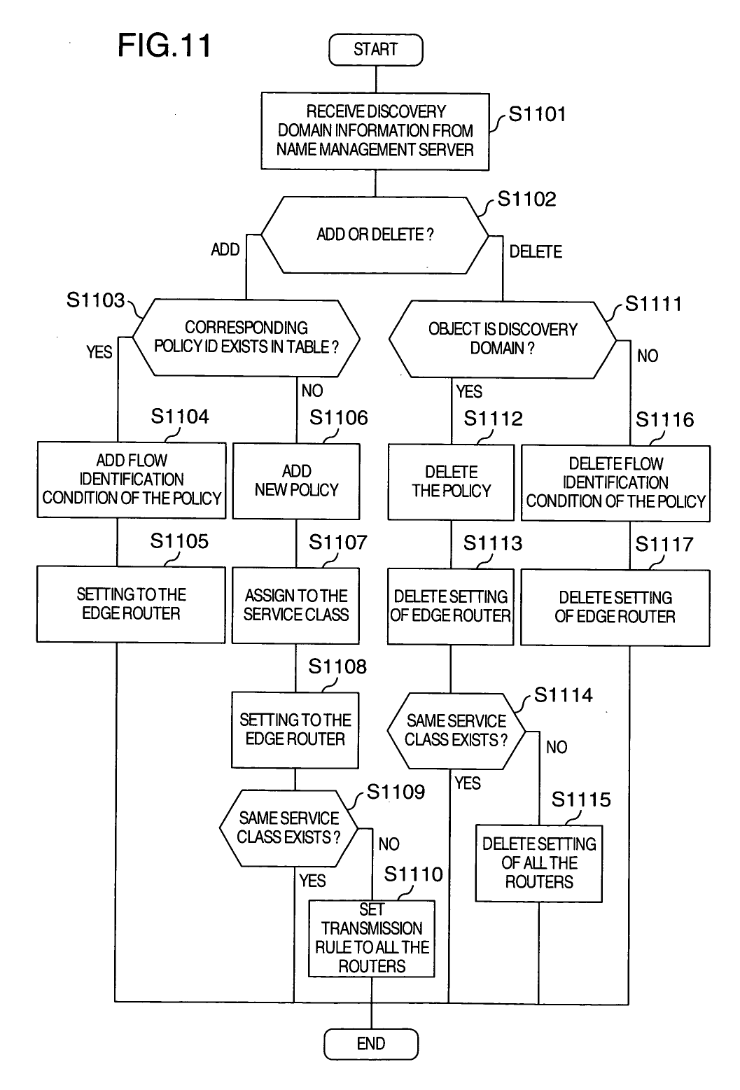

FIG. 11 is a flowchart explaining processing operation of the QoS setting program in the network setting server when it acquires information.

As the acquisition method of the discovery domain information, there is a method as follows. During the initial building of the network configuration server 102, the network configuration serves transmits an acquisition request to the name management server and acquires information on all the discovery domains registered, as a response from the name management server. The network configuration server transmits a notification registration request so that registration is made for that when the name management information is changed, notification is transmitted. The network configuration server 102 requests information acquisition and change notification for all the discovery domains as the management information.

(1) Firstly, the network configuration server 102 acquires the discovery domain information from the name management server 101. The information acquired here includes the domain identification number, and the address and the port number as portal information on the host and the storage apparatus belonging to the domain, from the information managed by the name management server explained in FIG. 7 (step S1101).

(2) The information notified from the name management server 101 by the process of step S1101 includes information indicating whether the object addition or deletion. The network configuration server 102 judges whether the notified information is addition or deletion (step 1102).

(3) When the step S1102 judges that the information is addition, the network configuration server searches to find a policy ID corresponding to the discovery domain ID notified to the QoS setting table managed (step S1103).

(4) When the search of step S1103 results in finding the corresponding policy ID, the network configuration server adds its entry flow identification condition by the added object condition and sets the addition to the edge router, thereby terminating the process (steps S1104, S1105).

(5) When the search of step S1103 could not find any corresponding policy ID, the network configuration registers a flow identification condition as a new policy and assigns a service class (steps S1106, S1107).

(6) The network configuration server sets the flow setting condition to the edge router and checks whether any other policy having the assigned service class is present. In the case of a new service class, the network configuration server decides the transmission rule for the service class and sets for all the routers, thereby terminating the process. When there is the same service class, the network configuration server performs nothing and terminates the process (steps S1108 to S1110).

(7) When step S1102 judges that the information is deletion, the network configuration server judges whether the deletion item is a discovery domain or node and portal belonging to the domain (step S1111).

(8) When step S1111 judges that the deletion item is a discovery domain, the network configuration server deletes the entry of the corresponding policy from the table and the setting of the flow identification condition from the edge router (steps S1112, S1113).

(9) Furthermore, the network configuration server checks whether there is a policy using the same service class. If there is one, the network configuration server performs nothing and terminates the process. If none, the network configuration server deletes the transmission rule for the corresponding service class from all the routers and terminates the process (steps S1114, S1115).

(10) When step S1111 judges that the deletion item is not a discovery domain but an object belonging to the discovery domain, the network configuration server identifies the flow identification condition including the object of the policy and deleted from the table. Moreover, the network configuration server deletes the setting condition of the edge router and terminates the process (steps S1116, S1117).

In the aforementioned process, when the network configuration server acquires information on a plurality of discovery domains at once in step 1101, the network configuration server executes the process of step S1102 repeatedly for each of the discovery domain information. When the network configuration server completes the process, the system returns a status to wait for a notification.

As another method for processing operation when the network configuration server acquires the QoS setting program information, the network configuration server ca periodically inquire the name management server about the information on all the discovery domains and acquires information, thereby detecting addition and/or deletion of the host and storage apparatus registered and judging whether addition or deletion of a discovery domain or an object in the same way as the process explained above so as to change the setting information to the router.

Moreover, even when the addition or deletion of a node and/or a portal is notified from the name management server, it is possible to confirm matching between the discovery domain information managed by the name management server and the QoS setting information managed by the network configuration server by periodical information acquisition.

In the example explained above, the QoS control is performed for each of the storage apparatuses. Next, explanation will be given on a method for performing QoS control for each logical unit of the storage apparatus.

In the embodiment of the present invention, a flow is identified by an address and a port number. Accordingly, the storage apparatus 104 has a plurality of network I/F and when each of them is set to be used for each logical unit, portal information has a different address. For this, when defining the discovery domain, by registering the portal information for each network I/F in different discovery domains, it becomes possible to identify the flow during transmission for each logical unit and perform QoS control for each logical unit by the aforementioned method of the embodiment of the present invention.

When the storage apparatus does not have the network I/F for each logical unit, it is possible to identify with the logical port. In this case, the storage system manager defines the node for each logical unit and makes setting so that a connection from the host can be accepted by a portals having different port numbers. The storage apparatus may have configuration identical to the one explained with reference to FIG. 2.

The logical unit 205 permits access by using the logical port 207. The correspondence is 1:1 and access using another logical port is not accepted. Such access control information is stored in the storage apparatus. For example, when there are two logical units of numbers 1 and 2, two nodes having different names are defined and the logical ports are defined as portals 1 and 2 having different port numbers, which are respectively registered as discovery domains 1 and 10 in the name management server. Here, reference is made to the registration contents of the name management information table shown in FIG. 7. The relationship between the node and the portal is made clear by setting different portal group numbers 100 and 200, for example. The host accessing the logical unit 1 is portal 1 while the host accessing the logical unit 2 is portal 2. Thus, they may be registered so as to belong to the same discovery domain. Here, they are registered in the entries 706 and 707. The entries 706 and 707 are identifies as flows by the aforementioned method according to the embodiment of the present invention and the QoS control is performed by the network.

As has been described above, the network configuration server can automatically acquire information managed by the name management server and set QoS control information for each discovery domain. Thus, in transmission between a plurality of hosts and storage apparatuses belonging to the same discovery domain, the QoS control can be performed by the common condition.

Next, in the aforementioned embodiment of the present invention, explanation will be given on the data transfer in the storage network system shown in FIG. 1.

As has been explained above, the system shown in FIG. 1 is managed as two discovery domains. The network configuration server 102 acquires the discovery domain information from the name management server 101 and creates a flow recognition condition as shown in FIG. 9A, assuming the information on the discovery domain 1 as policy 1 and the information on the discover domain 2 as policy 2. The service class Gold is assigned for policy 1 and the service class Silver is assigned for policy 2. The queue control in the router is shown in FIG. 9B and the flow recognition condition and the transmission rule are set in the router.

Here, it is assumed that the data access to the storage apparatus 104A from the job server 103A belonging to the discovery domain 1 and the data access to the storage apparatus 104B from the job server 103B belonging to the discovery domain 2 are performed substantially at the same timing. In this case, a packet accompanying the respective data access is input to the edge router from the respective network interface 304. The QoS control program recognizes the flow 1 and the flow 2 and sets DCSP in the packet header. These flows are put into the output queue so that they are output to the network connected to the core router. Here, there are four types of output queues. According to the transmission rule, the flow 1 is put into the queue of priority 1 and the flow 2 is put into the queue of priority 2. The output processing is started with the queue of priority 1 and the flow 1 is output firstly. The core router 105 judges the output queue by considering the DCSP in the packet and like the edge router, puts the flow 1 into the queue of priority 1 and the flow 2 into the queue of priority 2, and outputs the queue of the priority 1 firstly.

As has been described above, the data of the flow 1 transmitted between the apparatuses of the discovery domain 1 is output with a higher priority than the data of the flow 2 transmitted between the apparatuses of the discovery domain 2. Thus, it is possible to perform transmission with a high rate.

Next, explanation will be given on priority assignment to the discovery domain when performing registration in the name management server as an example of another control method in the embodiment of the present invention.

The name management server 101 receives registration from the manager via the I/O I/F 605. The manager of the storage network system assigns priority by considering the logical unit access frequency and importance of data when defining the discovery domain for the name management server 101 so as to limit the access right to the logical unit. This priority assignment may also be performed by selecting the priority class which can define whether to set priority by the user I/F. In the name management table as the name management information 607 held by the name management server 101 explained in FIG. 7, the priority field 705 is added in addition to the information such as the node and portal belonging to the discovery domain used in the embodiment of the present invention. When priority is set in the registration from the manager, a setting value is registered in the priority field 705 of the corresponding entry in the table. Here, the classes number of the priority and the identifier set by the manager may not consider the network setting. For example, it is possible to provide priority classes 1-10 (1 has the highest priority) which can be selected arbitrarily. In the name management information table shown in FIG. 7, priority 1 is set in the discovery domain of the entry 706 and priority 2 is set in the discovery domain of the entry 707.

When the network configuration server 102 acquires the discovery domain information from the name management server 101, it also acquires priority for the discovery domain in addition to the aforementioned information in the embodiment. The acquisition method is the same as the aforementioned embodiment. When the network configuration server 102 assigns a service class by using the address which is portal information on the node belonging to the discovery domain as a flow identification condition, it decides the service class and the transmission rule according to the priority acquired. The information on the service class managed by the network configuration server is identical to the one explained with reference to FIG. 9B. Here, if the priority class number and the designation method acquired from the name management server 101 are different from the class identifier of FIG. 9B, the network configuration server 102 makes correlation of them.

FIG. 12 shows a service class mapping table in the example of the network configuration server explained here. This table includes a service class field 1201 used for network setting and the corresponding discovery domain priority field 1202. For example, as has been described above, when the classes registered in the name management server are 1 to 5 and the services classes used by the network configuration server are Gold to default, class 0 or class 1 or above are correlated to the service classes Gold to default for management. In the example of FIG. 12, when the priority of the discovery domain information acquired is 1, the service class as the network setting information is decided to be Gold.

In the same way as has been described above, the flow identification condition and the transmission rule decided are respectively set in the edge router and the core router. The discovery domain acquired and not having priority set, default is set or nothing may be set.

As has been described above, the storage system manager can sets the priority of the QoS control in the network for the discovery domain. Moreover, the service class assigned by the network configuration server is matched with the request for the discovery domain. Thus, it is possible to set these effectively.

It should be further understood by those skilled in the art that although the foregoing description has been made on embodiments of the invention, the invention is not limited thereto and various changes and modifications may be made without departing from the spirit of the invention and the scope of the appended claims.

1. A control method of a storage network system including a plurality of information processing apparatuses and a plurality of storage apparatuses, the storage network system being connected to a name management server and a network configuration server,
wherein the name management server manages domain information used for searching storage apparatuses accessible by information processing apparatuses, and
wherein the network configuration server which acquires domain information managed by the name management server and sets network control information per domain to devices constituting the network.

2. A control method of a storage network system as claimed in claim 1, wherein the network control information set by the network configuration server to the devices constituting the network includes a service class allocation method and a control method per service class.

3. A control method of a storage network system as claimed in claim 1, wherein the network control information set by the network configuration server to the devices constituting the network includes at least one of priority control according to the service class, bandwidth control, and packet drop control.

4. A control method of a storage network system as claimed in claim 1, wherein when the domain information managed by the name management server is changed, the name management server notifies the change to the network configuration server and the network configuration server sets the change of the network control information based on the changed domain information to the devices constituting the network.

5. A control method of a storage network system as claimed in claim 1, wherein the network configuration server periodically acquires the domain information managed by the name management server and, if any change is made, the network configuration server sets the change of the network control information to the devices constituting the network.

6. A control method of a storage network system as claimed in claim 1, wherein the domain information registered in the name management server has a priority assigned.

7. A control method of a storage network system as claimed in claim 6, wherein the network configuration server correlates the priority registered in the name management server to the service class managed by the network configuration server.

8. A storage network system including a plurality of information processing apparatuses and a plurality of storage apparatuses, the storage network system being connected to a name management server and a network configuration server,
wherein the name management server having means which manages domain information used for searching a storage apparatuses accessible by information processing apparatuses, and
wherein a network configuration server having means which acquires domain information managed by the name management server and means which sets network control information per domain to devices constituting the network.

9. A storage network system as claimed in claim 8, wherein the network control information set by the network configuration server to the devices constituting the network includes a service class allocation method and a control method per service class.

10. A storage network system as claimed in claim 8, wherein the network control information set by the network configuration server to the devices constituting the network includes at least one of priority control according to the service class, bandwidth control, and packet dropping control.

11. A storage network system as claimed in claim 8, wherein when the domain information managed by the name management server is changed, the name management server further includes means which notifies the change to the network configuration server and the means of the network configuration server which sets the network control information to the devices constituting the network sets the change of the network control information based on the changed domain information to the devices constituting the network.

12. A storage network system as claimed in claim 8, wherein the network configuration server includes means which periodically acquires the domain information managed by the name management server and, if any change is made, the means of the network configuration server which sets the network control information to the devices constituting the network sets the change of the network control information to the devices constituting the network.

13. A storage network system as claimed in claim 8, wherein the domain information registered in the name management server has a priority assigned.

14. A storage network system as claimed in claim 13, wherein the network configuration server correlates the priority registered in the name management server to the service class managed by the network configuration server.

15. A storage network system comprising:
a plurality of information processing apparatuses; and
a plurality of storage apparatuses,
wherein the storage network system being connected to a name management server and a network configuration server,
wherein the name management server manages domain information used for searching a storage apparatus accessible by the information processing apparatuses, and
wherein the network configuration server which acquires domain information managed by the name management server and sets network control information per domain to devices constituting the network.
